(19) United States
(12) Patent Application Publication
(10) Pub. No.: US 2013/0016905 A1
(43) Pub. Date: Jan. 17, 2013

(54) METHOD AND APPARATUS FOR CORRECTING COLOR DISTORTION

(71) Applicants: Byung-kwan PARK, Seoul (KR); Won-hee Choe, Seoul (KR); Seong-deok Lee, Seongnam-si (KR)

(72) Inventors: Byung-kwan PARK, Seoul (KR); Won-hee Choe, Seoul (KR); Seong-deok Lee, Seongnam-si (KR)

(21) Appl. No.: 13/545,337

(22) Filed: Jul. 10, 2012

(30) Foreign Application Priority Data
Jul. 12, 2011 (KR) 10-2011-0068974

(51) Int. Cl. G06K 9/00

(52) U.S. Cl. 382/167

(57) ABSTRACT

A method and apparatus for correcting color distortion are provided. The method includes detecting a color image of an object. The method further includes correcting color distortion of the detected color image to generate a corrected color image. The method further includes synthesizing color information of the corrected color image and detail information of the detected color image to generate a synthesized color image.

### CROSS-REFERENCE TO RELATED APPLICATIONS

This application claims the benefit under 35 U.S.C. §119(a) of Korean Patent Application No. 10-2011-0068974, filed on Jul. 12, 2011, in the Korean Intellectual Property Office, the entire disclosure of which is incorporated herein by reference for all purposes.

### BACKGROUND

1. Field

The following description relates to methods and apparatuses for correcting color distortion, and more particularly, to methods and apparatuses for correcting color distortion to prevent noise from increasing while the color distortion is corrected.

2. Description of the Related Art

When an image sensor captures a color image of a subject, color distortion may occur. That is, colors of the image may be partially different than actual colors of the subject. The color distortion may be caused by various reasons. For example, the color distortion may occur due to crosstalk between pixels included in the image sensor. The color distortion may occur due to problems that may arise when a color filter is used, that is, when it is difficult to form a dye corresponding to the human visual characteristics and/or when characteristics of the dye change during deposition of the dye. In addition, the color distortion may occur when the image sensor includes infrared (IR) pixels and IR rays are introduced to red, green, and blue (RGB) pixels due to incompleteness of an IR shielding filter. As semiconductor technologies advance, the sizes of image sensors and pixels are reduced, and crosstalk is much more likely to occur. Thus, the need to correct color distortion is increasing.

In order to correct color distortion, a method of multiplying a captured color image by a gain has been used. That is, as a color distortion degree increases, the gain is increased. However, a value of a noise component included in an image to be corrected is also increased.

### SUMMARY

In a general aspect, there is provided a method of correcting color distortion, including detecting a color image of an object. The method further includes correcting color distortion of the detected color image to generate a corrected color image. The method further includes synthesizing color information of the corrected color image and detail information of the detected color image to generate a synthesized color image.

The detected color image may include an infrared (IR) region. The detail information of the detected color image may include detail information that is detected from an infrared (IR) region of the detected color image.

The synthesizing may include converting and dividing the detected color image into a chrominance image and a luminance image. The synthesizing may further include converting and dividing the corrected color image into a chrominance image and a luminance image. The synthesizing may further include extracting a low frequency component by decomposing the luminance image obtained by converting and dividing the corrected color image. The synthesizing may further include extracting a high frequency component by decomposing the luminance image obtained by converting and dividing the detected color image. The synthesizing may further include generating a color image by using the low frequency component, the high frequency component, and the chrominance image obtained by dividing the corrected color image.

The extracting of the low frequency component and the extracting of the high frequency component may include decomposing each of the luminance images obtained by converting and dividing the corrected color image and the detected color image into components corresponding to a plurality of frequency bands.

The extracting of the low frequency component and the extracting of the high frequency component may include performing edge-preserving filtering on each of the luminance images obtained by converting and dividing the corrected color image and the detected color image.

The generating of the color image may include inverse-decomposing the extracted low frequency component and the extracted high frequency component to generate a luminance image. The generating of the color image may further include inverse-converting the luminance image generated by inverse-decomposing and a chrominance image obtained by converting and dividing the corrected color image.

The correcting of color distortion may include multiplying each of red, green, and blue (RGB) components of the detected color image by a predetermined gain.

In another general aspect, there is provided an apparatus for correcting color distortion, including an image detecting unit configured to detect a color image of an object. The apparatus further includes a color correcting unit configured to correct color distortion of the detected color image to generate a corrected color image. The apparatus further includes an image synthesizing unit configured to synthesize color information of the corrected color image and detail information of the detected color image to generate a synthesized color image.

The image synthesizing unit may include a color conversion unit configured to convert and divide the detected color image into a chrominance image and a luminance image, and convert and divide the corrected color image into a chrominance image and a luminance image. The image synthesizing unit may further include an image decomposition unit configured to extract a low frequency component and a high frequency component by decomposing the luminance image obtained by converting and dividing the corrected color image and the luminance image obtained by converting and dividing the detected color image, respectively. The image synthesizing unit may further include an inverse image decomposition unit configured to inverse-decompose the low frequency component extracted from the luminance image obtained by converting and dividing the corrected color image and the high frequency component extracted from the luminance image obtained by converting and dividing the detected color image to output a luminance image. The image synthesizing unit may further include an inverse color conversion unit configured to inverse-convert the luminance image output by the inverse image decomposition unit and the chrominance image obtained by converting and dividing the corrected image color to output a color image.

The image decomposition unit may decompose each of the luminance images obtained by converting and dividing the corrected color image and the detected color image into components corresponding to a plurality of frequency bands.

The image decomposition unit may perform edge-preserving filtering on each of the luminance images obtained by converting and dividing the corrected color image and the detected color image.

The image decomposition unit may include a first low band filtering unit configured to perform low-band filtering on an input image of the image decomposition unit. The image decomposition unit may further include a first contrast image producing unit configured to output an image obtained by subtracting an output image of the first low band filtering unit from the input image of the image decomposition unit. The image decomposition unit may further include a second low band filtering unit configured to perform low-band filtering on the output image of the first low band filtering unit. The image decomposition unit may further include a second contrast image producing unit configured to output an image obtained by subtracting an output image of the second low band filtering unit from the output image of the first low band filtering unit. The image decomposition unit may further include a frequency selecting unit configured to select and output at least one from among the output of the second low band filtering unit and outputs of the first and second contrast image producing units.

The color correcting unit may multiply each of red, green, and blue (RGB) components of the detected color image by a predetermined gain.

A non-transitory computer readable recording medium may have recorded thereon a program for executing the method.

Other features and aspects may be apparent from the following detailed description, the drawings, and the claims.

### BRIEF DESCRIPTION OF THE DRAWINGS

FIG. 1 is a block diagram illustrating an example of an apparatus configured to correct color distortion.

FIG. 2 is a detailed block diagram illustrating an example of an image synthesizing unit of FIG. 1.

FIG. 3 is a detailed block diagram illustrating an example of an image decomposition unit of FIG. 2.

FIGS. 4 through 6 are flowcharts illustrating an example of a method of correcting color distortion.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

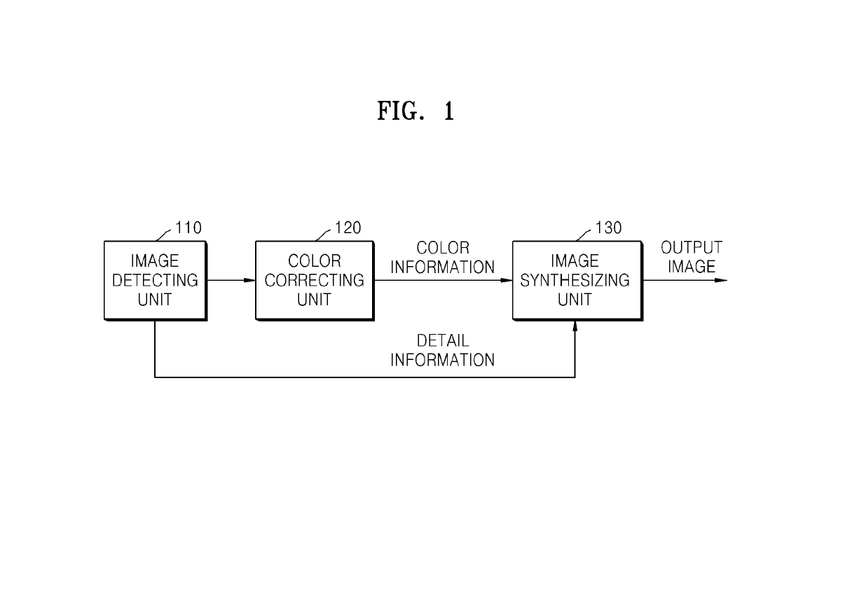

FIG. 1 is a block diagram illustrating an example of an apparatus configured to correct color distortion. The apparatus includes an image detecting unit 110, a color correcting unit 120, and an image synthesizing unit 130.

The image detecting unit 110 photographs an object and detects a color image of the object. The image detecting unit 110 may include, for example, a image sensor including red, green, and blue (RGB) pixels, or an image sensor including infrared (IR) pixels in addition to RGB pixels. Color distortion may occur in the image and may be caused by crosstalk that is a phenomenon in which electrons are introduced between the pixels or IR rays are introduced to the RGB pixels. Due to the color distortion, a portion of the image may exhibit a different color from an actual color of the object.

The color correcting unit 120 corrects the color distortion that occurs in the image detected by the image detecting unit 110. The color correcting unit 120 corrects the color distortion using various methods. For example, the color correcting unit 120 may correct the color distortion by multiplying the image by a gain, as described with reference to the following equation.

$$\begin{matrix}[ \begin{matrix}{O}_{r} \\ {O}_{g} \\ {O}_{b}\end{matrix} ] = CCM * ( [ \begin{matrix}{I}_{r} \\ {I}_{g} \\ {I}_{b}\end{matrix} ] + [ \begin{matrix}{N}_{r} \\ {N}_{g} \\ {N}_{b}\end{matrix} ] ) \\ = CCM * [ \begin{matrix}{I}_{r} \\ {I}_{g} \\ {I}_{b}\end{matrix} ] + CCM * [ \begin{matrix}{N}_{r} \\ {N}_{g} \\ {N}_{b}\end{matrix} ]\end{matrix} \qquad ( 1 )$$

In Equation 1, O denotes an output image, I denotes an input image, N denotes a noise component of a corresponding image, and subscripts r, g, and b denote red, green, and blue components of the corresponding image, respectively. In more detail, I denotes a valid component indicating an image in the input image, and N denotes the noise component included in the corresponding image. CCM is a color correction matrix and denotes a gain that corrects color distortion.

As shown in Equation 1, color distortion may be corrected by multiplying the input image I by the color correction matrix CCM. However, since the noise component N is also multiplied by the color correction matrix CCM, a value of the noise component N included in the output image O is increased. In addition, since noise may have high frequencies, the increase in the value of the noise component N may relatively greatly affect a high frequency band of the output image O.

In an example, the image detected by the image detecting unit 110 may be divided into a chrominance image and a luminance image. The chrominance image is an image expressing a colorimetric difference between a predetermined color and a reference color under the same luminance condition. The luminance image is an image expressing pure luminance only. The chrominance image includes chrominance information. The luminance image includes approximation information in a low frequency band and includes detail information in a high frequency band. In this example, the chrominance information includes information indicating a colorimetric difference between a predetermined color and a reference color under the same luminance condition, e.g., characteristics of pure color. The approximation information includes information indicating brightnesses of objects included in an image while indicating an approximate shape of the objects. The combination of the chrominance information and the approximation information is color information of the image. The detail information includes information regarding curves indicating boundaries of the objects or edges where sharp changes in color or brightness occur in the image. Accordingly, the increase in noise during a color correcting process may greatly affect the detail information.

In this example, a reference frequency used to divide information of the luminance image into the approximation information and the detail information, may be ½ a maximum frequency of the image. The maximum frequency of the image may be a reciprocal of a resolution of the image sensor. Thus, for example, if the image sensor includes a resolution of 2 mm, a maximum frequency of the image is a reciprocal of 2 mm, that is, 500 Hz. Accordingly, with regard to the luminance image, a range of 250 Hz or less is a low frequency band for the approximation information, and a range of more than 250 Hz is a high frequency band for the detail information. However, this method of classifying frequencies into a high frequency band and a low frequency band is an example. The reference frequency may be set using various methods as long as the luminance image appropriately includes the approximation information and the detail information.

The image synthesizing unit 130 synthesizes the image corrected by the color correcting unit 120 and the image detected by the image detecting unit 110, to generate and output a synthesized color image. In more detail, the image synthesizing unit 130 synthesizes color information of the image corrected by the color correcting unit 120 and detail information of the image detected by the image detecting unit 110. In other words, the image synthesizing unit 130 extracts chrominance information from a chrominance image of the image corrected by the color correcting unit 120, the image synthesizing unit 130 extracts approximation information from a luminance image of the image corrected by the color correcting unit 120, and the image synthesizing unit 130 extracts detail information from a luminance image of the color image detected by the image detecting unit 110. The image synthesizing unit 130 combines the chrominance information, the approximation information, and the detail information, and generates and outputs the synthesized color image based on such information. Since the synthesized color image uses the color information of the corrected image, the synthesized color image has an effect of correcting color distortion in the detected image. In addition, the synthesized color image has a high signal-to-noise ratio (SNR) compared to that of the corrected image. This is because the synthesized color image uses detail information of the detected image that is not corrected, and the detail information of the detected image includes less noise components than the detail information of the corrected image.

In an example, if the image detected by the image detecting unit 110 includes an IR region component, the detail information of the IR region component and the color information of the corrected image are synthesized to generate and output the synthesized color image. Since the IR region component has low noise due to characteristics of a frequency band of the IR region, the IR region component has a relatively high SNR. Thus, by using the detail information of the IR region component, a SNR of the synthesized color image is increased.

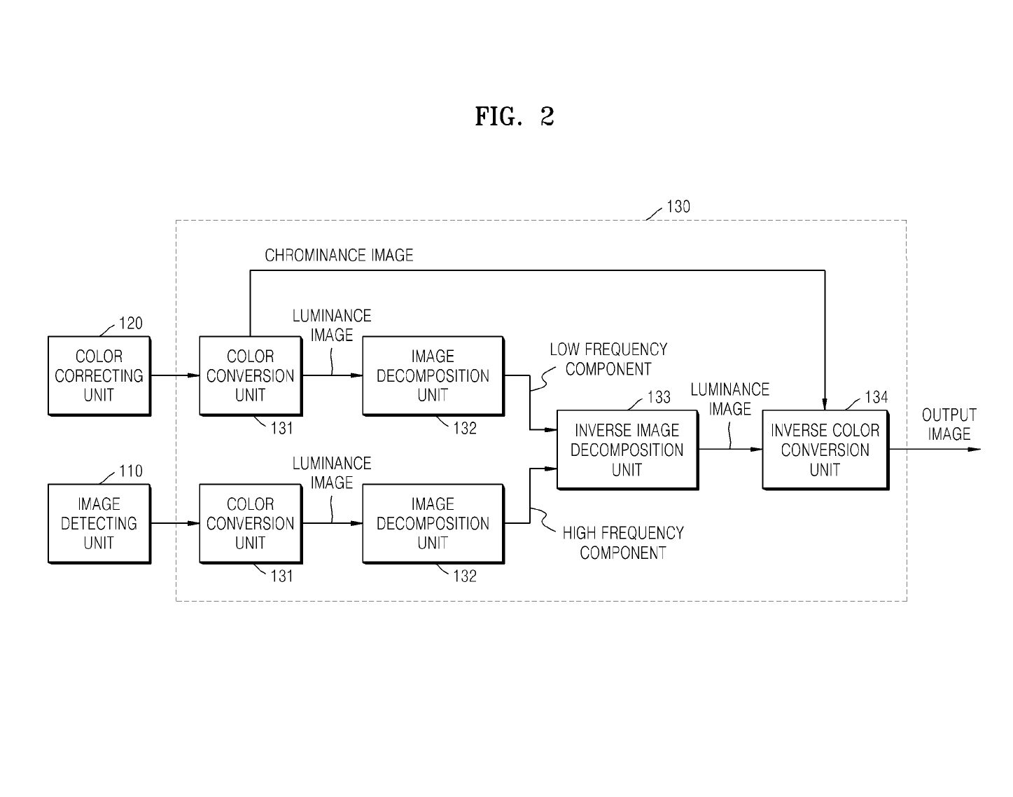

FIG. 2 is a detailed block diagram illustrating an example of the image synthesizing unit 130 of FIG. 1. The image synthesizing unit 130 includes at least one color conversion unit 131, at least one image decomposition unit 132, an inverse image decomposition unit 133, and an inverse color conversion unit 134.

The color conversion unit 131 converts an image corrected by the color correcting unit 120 and an image detected by the image detecting unit 110, and divides each of the images into a chrominance image and a luminance image. For example, the color conversion unit 131 may convert an RGB image input thereto into a YCbCr image, and may divide the YCbCr image into a luminance image including a luminance component Y and a chrominance image including chrominance components Cb and Cr. In this example, the chrominance image includes chrominance information, and the luminance image includes approximation information and detail information. In more detail, the luminance image includes approximation information in a low frequency band and includes detail information in a high frequency band. The color conversion unit 131 outputs the luminance image of the corrected image and the luminance image of the detected image to the image decomposition unit 132. The color conversion unit 131 further outputs the chrominance image of the corrected image to the inverse color conversion unit 134.

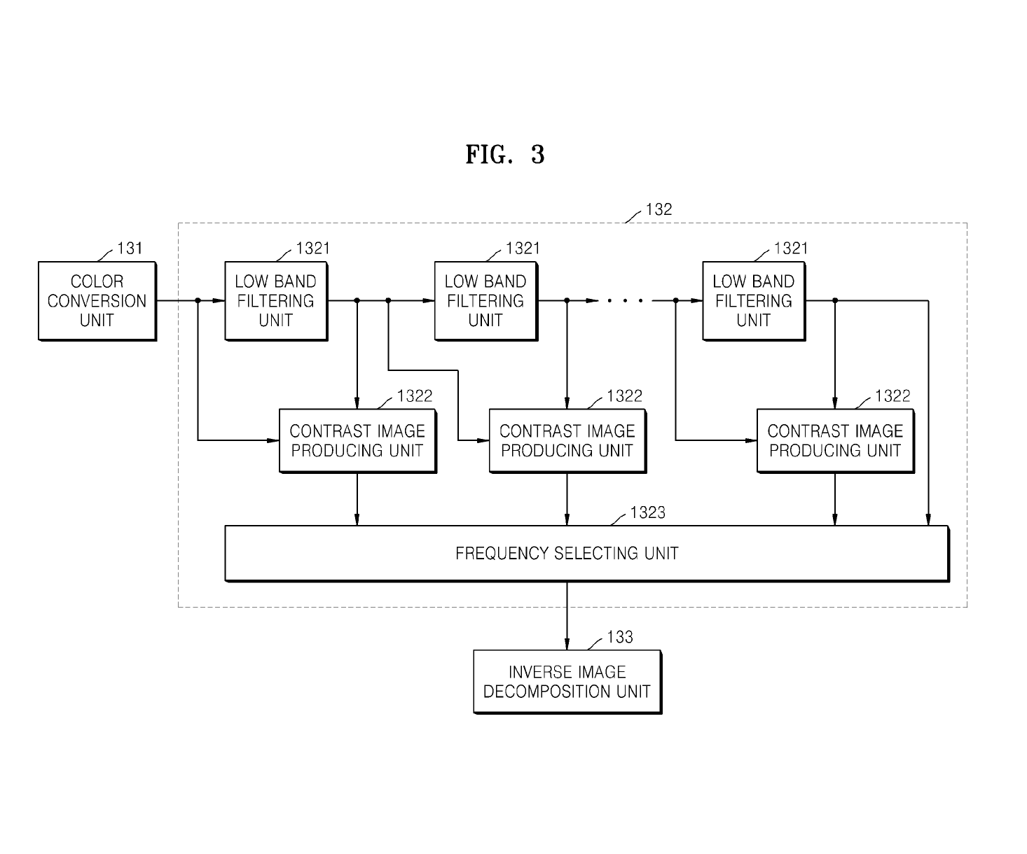

The image decomposition unit 132 decomposes the luminance image of the corrected image and the luminance image of the detected image to extract and output a high frequency component and a low frequency component. In more detail, the low frequency component includes approximation information, and is extracted and output from the luminance image obtained by dividing the corrected image. In this example, the low frequency component may be a component having a frequency of ½ a maximum frequency of an image or less. The high frequency component includes detail information, and is extracted and output from the luminance image obtained by dividing the detected image. In this example, the high frequency component may be a component having a frequency more than ½ the maximum frequency of the image. The image decomposition unit 132 may extract the high and low frequency components using a frequency filtering process. For example, the frequency filtering process may include a multi-layer decomposition method of decomposing an image into components corresponding to a plurality of frequency bands. A detailed structure of the image decomposition unit 132 using the multi-layer decomposition method will be described later with reference to FIG. 3.

The inverse image decomposition unit 133 receives and inverse-decomposes the low frequency component of the luminance image obtained by dividing the corrected image, and the high frequency component of the luminance image obtained by dividing the detected image, to generate and output another luminance image. That is, the other luminance image generated and output from the inverse image decomposition unit 133, includes the approximation information of the corrected image and the detail information of the detected image.

The inverse color conversion unit 134 receives and inverse-converts the other luminance image output from the inverse image decomposition unit 133, and the chrominance image obtained by converting the corrected image, to generate and output a synthesized color image. That is, the synthesized color image generated and output from the inverse color conversion unit 134, includes the color information of the corrected image and the detail information of the detected image.

FIG. 3 is a detailed block diagram illustrating an example of the image decomposition unit 132 of FIG. 2. The image decomposition unit 132 includes a plurality of low band filtering units 1321, a plurality of contrast image producing units 1322, and a frequency selecting unit 1323.

The low band filtering units 1321 are connected in serial to each other so that an output of any one of the low band filtering units 1321 is an input of another one of the low band filtering units 1321. In addition, each of the contrast image producing units 1322 receives an input image and an output image of a corresponding one of the low band filtering units 1321. Each of the contrast image producing units 1322 subtracts the output image from the input image to generate and output a contrast image to the frequency selecting unit 1323.

In more detail, a first low band filtering unit 1321 receives an input image of the image decomposition unit 132 (e.g., the luminance image of the corrected image and/or the luminance image of the detected image from the color conversion unit 131), and performs low-band filtering of the input image based on a predetermined frequency. A second low band filtering unit 1321 receives a result of the first low band filtering unit 1321, and performs low-band filtering of the result based on a lower frequency than that of the first low band filtering unit 1321. Third, fourth, through Nth low band filtering units 1321 receives respective results, and performs low-band filtering of the results based on predetermined frequencies, respectively. In this example, the predetermined frequencies gradually reduce in value towards the predetermined frequency of the Nth low band filtering unit 1321. A first contrast image producing unit 1322 receives an input image and an output image of the first low band filtering unit 1321, and subtracts the output image from the input image to generate and output a contrast image to the frequency selecting unit 1323. Second and third contrast image producing units 1322 receive input images and output images of the second and third low band filtering units 1321, respectively, and subtracts the output images from the input images to generate and output contrast images to the frequency selecting unit 1323.

In even more detail, the low band filtering units 1321 perform edge-preserving filtering to preserve an edge region between images so as to prevent ringing in the edge region during synthesis of the images. The edge-preserving filtering may include, for example, weighted least squares (WLS) filtering. Hereinafter, a method of performing the WLS filtering using a multi-layer decomposition method will be described with reference to the following equations.

Out=W_{λ}(In)=(I+λL_{g})⁻¹ In (2)

In Equation 2, Out and In denote an output image and an input image, respectively. The input image In is output as the output image Out through a WLS filter W_{λ}. In this example, the WLS filter W_{λ} is determined according to a smoothing factor λ. That is, as λ is increased, a smoothing effect is improved. As described above, I denotes a valid component indicating an image in the input image In. In addition, L_{g} may be determined according to the following equation.

L_{g}=Dₓ^{T}AₓDₓ+D_{y}^{T}A_{y}D_{y} (3)

In Equation 3, Dₓ and D_{y} denote difference operators, and Aₓ and A_{y} denote smoothness weights, which are determined with respect to the input image In.

For example, an initial input image into the image decomposition unit 132 may be I₀, and an approximation output image and a detail output image from a level k (e.g., first one, second one, etc.) of the low band filtering units 1321 may be Iₖ^{a} and Iₖ^{d}, respectively. The multi-layer decomposition method may be performed on a plurality of levels of the low band filtering units 1321 according to Equations 4 and 5 below. In this example, the approximation output image corresponds to a low frequency component (e.g., approximation information) of the initial input image and the detail image corresponds to a high frequency component (e.g., detail information) of the initial input image.

$$\begin{matrix}{I}_{k + 1}^{a} = \text{?} ( {I}_{0} ) & ( 4 ) \\ {I}_{k}^{d} = \frac{{I}_{k - 1}^{a} - {I}_{k}^{a}}{{I}_{k}^{a}} \\ \text{?} \text{indicates text missing or illegible when filed} & ( 5 )\end{matrix}$$

The frequency selecting unit 1323 selects necessary output images from among the contrast images output from the contrast image producing units 1322 and an output image of a last low band filtering unit 1321 that performs a last low-band filtering. The frequency selecting unit 1323 outputs the necessary output images or information of the necessary output images as an output of the image decomposition unit 132, e.g., a low frequency component and/or a high frequency component as described in FIG. 2. Since an image input into the image decomposition unit 132 is decomposed into images of a plurality of frequency bands that are input into the frequency selecting unit 1323, the frequency selecting unit 1323 extracts at least one desired image of a low frequency and/or a high frequency from the images of the frequency bands.

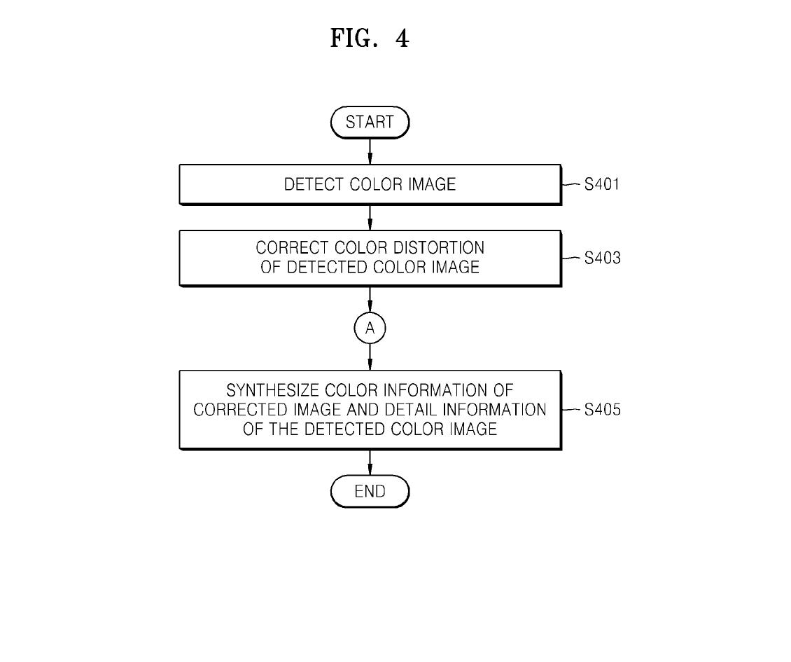

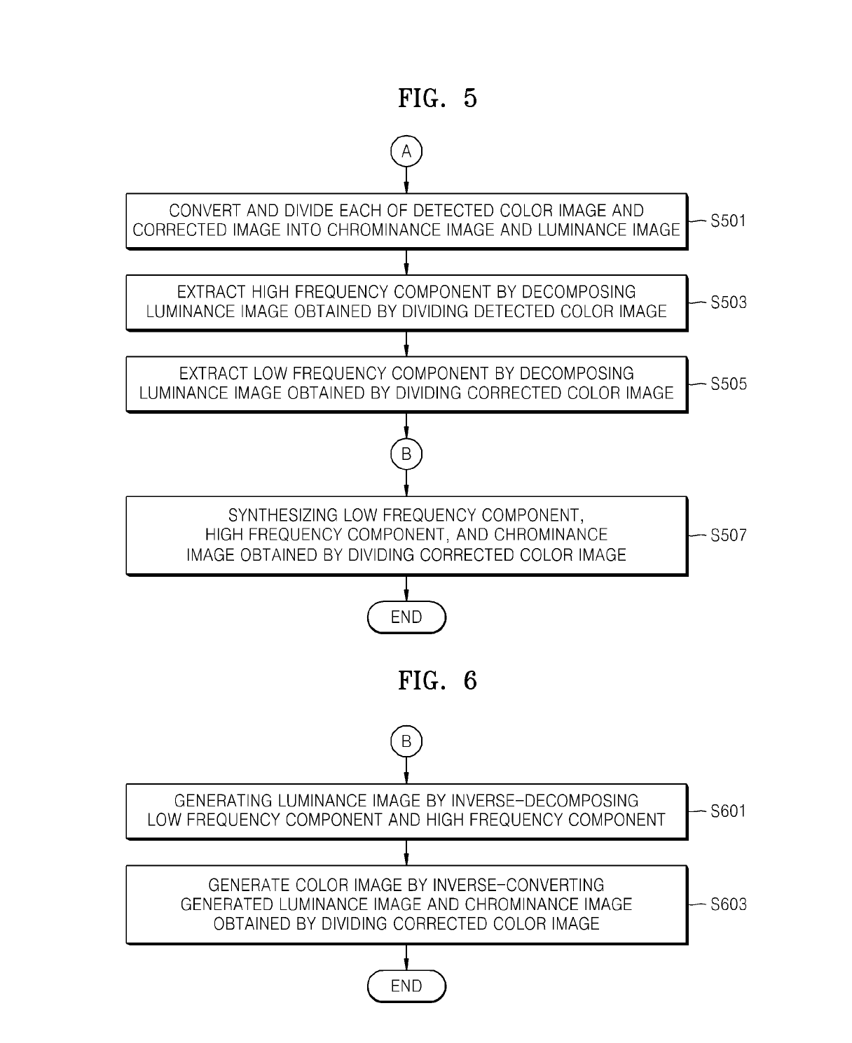

FIGS. 4 through 6 are flowcharts illustrating examples of a method of correcting color distortion. In more detail, FIG. 4 is a flowchart illustrating an example of a method of correcting color distortion. FIG. 5 is a flowchart illustrating an example of operation S405 of FIG. 4. FIG. 6 is a flowchart illustrating an example of operation S507 of FIG. 5. For example, the method of correcting color distortion may be performed by the apparatus of FIGS. 1 through 3.

With reference to FIG. 4, at operation S401, an object is photographed and a color image of the object is detected. In this example, color distortion may exist in the image due to crosstalk between pixels of an image sensor performing the photographing, or due to incompleteness of a color filter. Thus, at operation S403, the color distortion of the detected color image is corrected. However, if the color distortion is corrected by multiplying the image by a gain, noise included in the image may be increased. In addition, as a color distortion degree increases, the gain needs to be increased, and thus, the noise is further increased. In order to overcome these problems, at operation S405, color information of the corrected image and detail information of the detected color image are synthesized to generate and output a synthesized color image. Since the synthesized color image uses the color information of the corrected image, the color image has an effect of correcting color distortion in the detected image. In addition, since the synthesized color image uses the detail information of the detected image having low noise, the synthesized color image has a high SNR compared to that of the corrected image. Operations included in operation S405 of synthesizing the color information of the corrected image and the detail information of the detected image will be described with reference to FIG. 5.

Referring to FIG. 5, at operation S501, each of the detected color image and the corrected image is converted and divided into a chrominance image and a luminance image, respectively (operation S501). For example, an RGB image may be converted into a YCbCr image, and then may be divided into the luminance image including a luminance component Y and the chrominance image including chrominance components Cb and Cr. The chrominance image includes chrominance information. The luminance image includes approximation information in a low frequency band and includes detail information in a high frequency band. In this example, the chrominance information includes information indicating a colorimetric difference between a predetermined color and a reference color under the same luminance condition, e.g., characteristics of pure color. The approximation information includes information indicating brightnesses of objects included in a detected or corrected image while indicating an approximate shape of the objects. A combination of the chrominance information and the approximation information is color information of the image. The detail information includes information regarding curves indicating boundaries of the objects, or edges where sharp changes in color or brightness occur in the image.

In this example, a reference frequency used to divide information of the luminance image into the approximation information and the detail information, may be ½ a maximum frequency of the image. The maximum frequency of the image may be a reciprocal of a resolution of an image sensor. Thus, for example, if the image sensor includes a resolution of 2 mm, the maximum frequency of the image is a reciprocal of 2 mm, that is, 500 Hz. Accordingly, with regard to the luminance image, a range of 250 Hz or less is a low frequency band for the approximation information, and a range of more than 250 Hz is a high frequency band for the detail information. However, this method of classifying frequencies into a high frequency band and a low frequency band is a just an example. The reference frequency may be set using various methods as long as the luminance image appropriately includes the approximation information and the detail information.

At operation S503, a high frequency component is extracted by decomposing the luminance image obtained by dividing the detected color image. That is, the high frequency component including detail information of the detected image, is extracted from the detected image. At operation S505, a low frequency component is extracted by decomposing the luminance image obtained by dividing the corrected color image. That is, the low frequency component including approximation information of the corrected image, is extracted from the corrected image. At operation S507, the low frequency component, the high frequency component, and the chrominance image obtained by divining the corrected color image, are synthesized to generate and output the synthesized color image. As a result, the synthesized color image includes the color information of the detected image and the detail information of the corrected image. Thus, the synthesized color image has an effect of correcting color distortion, and has a high SNR compared to that of the corrected image. Operations included in operation S507 of synthesizing the low frequency component, the high frequency component, and the chrominance image will be described with reference to FIG. 6.

Referring to FIG. 6, at operation S601, the high and low frequency components, are inverse-decomposed to generate and output another luminance image. At operation S603, this generated luminance image and the chrominance image obtained by dividing the corrected image, are inverse-converted to generate and output the synthesized color image, thereby completing the method.

According to the teachings above, there is provided a method and apparatus for synthesizing color information of a detected image that is corrected using a method of correcting color distortion, and detail information of the detected image that is not corrected. Accordingly, an effect of correcting color distortion is obtained, while preventing noise from increasing. In addition, image decomposition that is performed during synthesis of images, is performed using an edge-preserving frequency filtering method, thereby preventing ringing in an edge region during the synthesis of the images.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments for accomplishing the examples disclosed herein can be easily construed by programmers skilled in the art to which the examples pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of correcting color distortion, comprising:
detecting a color image of an object;
correcting color distortion of the detected color image to generate a corrected color image; and
synthesizing color information of the corrected color image and detail information of the detected color image to generate a synthesized color image.

2. The method of claim 1, wherein:
the detected color image comprises an infrared(IR) region; and
the detail information of the detected color image comprises detail information that is detected from an infrared (IR) region of the detected color image.

3. The method of claim 1, wherein the synthesizing comprises:
converting and dividing the detected color image into a chrominance image and a luminance image;
converting and dividing the corrected color image into a chrominance image and a luminance image;
extracting a low frequency component by decomposing the luminance image obtained by converting and dividing the corrected color image;
extracting a high frequency component by decomposing the luminance image obtained by converting and dividing the detected color image; and
generating a color image by using the low frequency component, the high frequency component, and the chrominance image obtained by dividing the corrected color image.

4. The method of claim 3, wherein the extracting of the low frequency component and the extracting of the high frequency component comprise decomposing each of the luminance images obtained by converting and dividing the corrected color image and the detected color image into components corresponding to a plurality of frequency bands.

5. The method of claim 3, wherein the extracting of the low frequency component and the extracting of the high frequency component comprise performing edge-preserving filtering on each of the luminance images obtained by converting and dividing the corrected color image and the detected color image.

6. The method of claim 3, wherein the generating of the color image comprises:
inverse-decomposing the extracted low frequency component and the extracted high frequency component to generate a luminance image; and
inverse-converting the luminance image generated by inverse-decomposing and a chrominance image obtained by converting and dividing the corrected color image.

7. The method of claim 1, wherein the correcting of color distortion comprises multiplying each of red, green, and blue (RGB) components of the detected color image by a predetermined gain.

8. An apparatus for correcting color distortion, comprising:
an image detecting unit configured to detect a color image of an object;
a color correcting unit configured to correct color distortion of the detected color image to generate a corrected color image; and
an image synthesizing unit configured to synthesize color information of the corrected color image and detail information of the detected color image to generate a synthesized color image.

9. The apparatus of claim 8, wherein:
the detected color image comprises an infrared (IR) region; and
the detail information of the detected color image comprises detail information that is detected from an infrared (IR) region of the detected color image.

10. The apparatus of claim 8, wherein the image synthesizing unit comprises:
a color conversion unit configured to
convert and divide the detected color image into a chrominance image and a luminance image, and
convert and divide the corrected color image into a chrominance image and a luminance image;
an image decomposition unit configured to extract a low frequency component and a high frequency component by decomposing the luminance image obtained by converting and dividing the corrected color image and the luminance image obtained by converting and dividing the detected color image, respectively;
an inverse image decomposition unit configured to inverse-decompose the low frequency component extracted from the luminance image obtained by converting and dividing the corrected color image and the high frequency component extracted from the luminance image obtained by converting and dividing the detected color image to output a luminance image; and
an inverse color conversion unit configured to inverse-convert the luminance image output by the inverse image decomposition unit and the chrominance image obtained by converting and dividing the corrected image color to output a color image.

11. The apparatus of claim 10, wherein the image decomposition unit decomposes each of the luminance images obtained by converting and dividing the corrected color image and the detected color image into components corresponding to a plurality of frequency bands.

12. The apparatus of claim 10, wherein the image decomposition unit performs edge-preserving filtering on each of the luminance images obtained by converting and dividing the corrected color image and the detected color image.

13. The apparatus of claim 10, wherein the image decomposition unit comprises:
a first low band filtering unit configured to perform low-band filtering on an input image of the image decomposition unit;
a first contrast image producing unit configured to output an image obtained by subtracting an output image of the first low band filtering unit from the input image of the image decomposition unit;
a second low band filtering unit configured to perform low-band filtering on the output image of the first low band filtering unit;
a second contrast image producing unit configured to output an image obtained by subtracting an output image of the second low band filtering unit from the output image of the first low band filtering unit; and
a frequency selecting unit configured to select and output at least one from among the output of the second low band filtering unit and outputs of the first and second contrast image producing units.

14. The apparatus of claim 8, wherein the color correcting unit multiplies each of red, green, and blue (RGB) components of the detected color image by a predetermined gain.

15. A non-transitory computer readable recording medium having recorded thereon a program for executing the method of claim 1.
